(19) United States
(12) Patent Application Publication
(10) Pub. No.: US 2020/0322055 A1
(43) Pub. Date: Oct. 8, 2020

(54) AIR, LAND AND SEA WIRELESS OPTICAL TELECOMMUNICATION NETWORK (ALSWOT)

(71) Applicant: Steven R Jones, Indio, CA (US)

(72) Inventor: Steven R Jones, Indio, CA (US)

(21) Appl. No.: 16/430,319

(22) Filed: Jun. 3, 2019

Related U.S. Application Data
(60) Provisional application No. 62/691,011, filed on Jun. 28, 2018.

(51) Int. Cl. H04B 10/29; H04B 10/27

(52) U.S. Cl. CPC H04B 10/29; H04B 10/27

(57) ABSTRACT

Systems and methods are disclosed with a plurality of remote controlled, located and monitored platform relays for global data transmission and reception, and at least one relay linked to a maritime vessel, a satellite and an air-based vehicle.

### BACKGROUND

The System of Systems (SOS) disclosed herein is related to global communication networks.

Presently global audio video and data communication networks utilize fiber optic submarine cable systems to transmit data between continents and other land masses or uplink and downlink data between satellites and receiving stations including hand held units. After crossing oceans data is distributed by underground cables or through the atmosphere via WIFI and telecommunication towers. Various combinations of methods are employed to create networks.

Trans Pacific Express (TPE), one of the latest fiber optic submarine cable systems, completed in 2008, is a cable that connects China, Korea and the United States. TPE is one of numerous submarine cables that span between continents, island nations, and along shorelines to globally distribute data. TPE exceeded $500M (2008 dollars) in construction costs for the 11,000 miles of cable connecting the two continents and three countries. TPE provides 60 times the capacity of the previous submarine cable retired in 2016 but to be expand bandwidth beyond that capacity additional cable must be laid. Submarine and underground cable systems have limited life, require the placement of additional cable to upgrade or expand capacity once deployed, and require highly specialized crews and capital-intensive specialized maritime vessels and other equipment for maintenance and repair.

All networks have unique disadvantages. Cables are routinely broken by anchors, earthquakes, fishing trawlers, and shark bites. Capital associated with cable placement is high, Maintenance, repair and replenishment is difficult requiring capital intensive specialized maritime repair vessels and highly trained crews. Global warming, rising sea levels, increasing hurricane strength and other weather threats are expected to further detrimentally impact both underground and submarine cable systems,

SOS in research and development include Airborne Systems of various nature including aircraft to aircraft, dirigible to dirigible, loitering unmanned aircraft and numerous combinations of the above methods. Aircraft subsystems used in these systems require approval and certification by the FCC and FAA. Unmanned Aerial Vehicles (UAV) and dirigible Wireless Systems also require FAA and FCC approval and certification. These SOS have numerous issues including limited loiter time, grounding due to unfavorable weather conditions and many other physical limits and restrictions. As noted, these SOS are subject to requirements of multiple regulatory agencies at the local, state, national and international level. FAA certification is a lengthy, costly process normally requiring multiple years for completion.

Data transmission using ALSWOT has far fewer issues than those noted in the above systems. ALSWOT issues arise from several primary issues.: (1) environmental conditions that impact operation, including corrosion and sea state conditions, (2) attenuation of broadcast signals resulting from atmospheric attenuation and energy reflection from water surfaces, and (3) security issues resulting from piracy and/or unstable governments. These limitations can be addressed and controlled by design. Stabilized Floating Drone Platform and Towers (SFDPT) design helps mitigates sea conditions, broadcast power levels can be increased to reduce attenuation, directionally oriented continuously self-aligned transceivers improve reception and limit reflection, and specialized geometry and material use in horn design enable enhanced beam focus and control.

Design practices including the use of selective materials and shapes, and localized electrical grounding helps focus energy transmission and reception thereby minimizing losses and interference or noise. Unstable and unlawful government intrusion are mitigated by movable equipment. ALSWOT, being based primarily in International and EEZ Zone Waters is not subject to the same power transmission limits or antennae height limits as land-based networks. Restrictions on land-based antennae heights are presently being reviewed to allow internet and cellular service to reach rural areas not presently covered by WIFI due to the economic factors caused by the current restrictions. Relaxing height restrictions can bring service to millions of rural customers in the continental US that presently must rely on either dial up or satellite communication services. Globally the number of individuals benefitting from ALSWOT freedom from restrictive regulations is in the billions. ALSWOT transmits at higher power levels enabling enhanced and repeatable transmission and reception over greater distances. Increased antennae heights and signal power levels allow increased distances between relays. Signal strength can also be increased to compensate for atmospheric attenuation. With respect to issues of physical security ALSWOT deployed in International Waters has greater freedom for self-protection than assets located in territorial and littoral waters.

Transmission or broadcast distances become functions of primarily platform height (LOS), stability and beam focus. Transmission signal strength compensates for the effects of atmospheric attenuation. ALSWOT further mitigates atmospheric attenuation issues using continuously self-aligned vertically stabilized platforms/towers. To further enhance reception and transmission, transceivers are attached to control arms using mounts that control and adjust pitch, roll and yaw with respect to adjacent transceivers on local vessels and platforms.

Pitch control arms (PCA) rotate perpendicular to the tower vertical axis to control and align orientation to adjacent transceivers located on towers, ships or nearby aircraft and satellites. PCA continuously self-align to the corresponding PCA on adjoining platforms or other devices. Gimballed mounts attached to the pitch control arms, provide further adjustment by allowing roll and yaw adjustments. Feedback Systems between SFDPT and other types of platforms monitor the positions on the surrounding platforms and continuously provide the optimal alignment between transceivers on adjoining platforms or resources.

Platform/antennae stability on commercial ships is controlled using three sets of actuators to provide a full six degrees of freedom and hence motion.

System linkage or connection of towers in territorial or littoral waters to land based towers can be via submarine cable, neutrally buoyant cable or by electromagnetic spectrum transmission.

All network SOS have disadvantages. Cables are routinely broken by anchors, earthquakes, fishing trawlers, and shark bites. Capital associated with cable placement is high, Maintenance, repair and replenishment is difficult requiring capital intensive specialized maritime repair vessels and highly trained crews. Global warming, rising sea levels, increasing hurricane strength and other weather threats are expected to further detrimentally impact both underground and submarine cable systems,

Stationary cable systems inherently possess numerous risks and cost drivers. Cyber security threats of known routing paths allow splicing or other methods of system breach, cost of land acquisition and/or lease required for cable placement, failure of in-line repeater amplifiers mentioned just a of these risks and cost drivers. Numerous other disadvantages exist that impact security, reliability and affordability. ALSWOT avoids these issues by transmitting wireless data between continuously stabilized, self-aligned and clocked transmission drone platforms/towers using self-aligned transceivers. ALSWOT routes between numerous drone platforms, maritime vessels, UAVs and along multiple routes to transmit data from sender to receiver. Data can be packaged and transmitted for later assembly. Transmission routes are continuously variable, constantly changing and flexible by system design. ALSWOT, not having data transmission constraints like the TPE, can add additional transceivers at will by adding additional drone platforms wherever and whenever extra transmission capacity is required.

Described in detail herein is a variant of ALSWOT to convey the scope of the SOS to those skilled in the art. ALSWOT is a SOS that replaces current submarine and land cable networks with a technologically advanced state-of-the-art global wireless network, broadcast atmospherically above oceans, lakes, fjords, river systems and along coastlines. ALSWOT is capable of continuous spiral development and upgrades including technology upgrade, expansion of upload and download data rates, and system expansion and modification. The SOS comprised of multiple, buoyant, stabilized, clocked, and continuously adjusted and aligned drone platforms/towers containing self-aligned antennae transmits and receive data in the wireless energy spectrum. The remotely located, remotely controlled and remotely positioned drone platforms, floating on oceans and other bodies of water including major river systems, creates a network primarily located in International and EEZ Zone Waters providing design freedom not available to the current land-based networks. Neutrally buoyant and submarine cable technology is used when required to comply with FCC or other local regulatory agencies. The SOS described herein conveys the scope of the invention to those skilled in the art.

Air, Land and Sea Wireless Optical Data Transmission (ALSWOT) is a SOS that transmits wireless data via Line of Sight (LOS) above water surfaces via Stabilized Drone Platforms and Towers (SDPT) using Linked Continuously Self-Aligned Antennae (LCSAA). ALSWOT also allows Over the Horizon (OTH) transmission via satellite, aircraft and other air borne UAV or dirigible mounted relays.

In this document for purpose of discussion a coordinate system containing six degrees of freedom is used. Translation along the three displacement directions of the coordinate system namely X, Y, and Z are referred to as surge, sway, and heave, respectively. Rotations about the X, Y, and Z axes, are referred to as pitch, roll and yaw, respectively. Surge is defined as fore-back movement, sway is defined as left-right or port-starboard, and heave as up-down motion. Vessel direction of primary travel is in the X direction. If the vessel is stationary, the local coordinate system is aligned to magnetic north with corresponding movements described relative to due north or 0° degrees. Furthermore, vessel location globally is identified relative to longitude and latitude consistent with the Global Positioning System use of coordinates. If the vessel is in motion the coordinate system is aligned to the primary direction of travel. When referring to data transmission direction the coordinate system is therefore aligned first to due north, then to direction of vessel travel and finally to direction of energy transmission.

Station locations of vessels are defined from the origin at STA (X=0, Y=0, Z=0). For example, a station location designated as STA (X23, Y5, Z10) is located 23 units AFT of STA X0 (with STA X=0 unless identified otherwise is vessel bow), along the starboard side of vessel displaced 5 units from vessel centerline located at STA (Y=0) and 10 Units above deck line designated as STA (Z=0). Right hand rule applies to positive Z direction.

The floating, motion stabilized, drone platforms contain linked LCSAA to transmit and receive data between aircraft, UAVs, satellites, blimps, and other maritime vessels. Vertically Stabilized Drone platforms (VSDPT), controlled using a plumb bob, gravity fluid leveling, spring mounted accelerometers or gyrocompass sensors feedback coupled to an electronic control system operate Subsurface Stabilizers and Thrusters (SSAT). SSAT provide horizontal and vertical thrust to keep the drone platforms aligned to vertical. Buoyancy adjustment using ballast tanks also help control stability. Platform alignment (PA) between drone platforms controls yaw or clocking of platforms using LORAN and magnetic field data as inputs to an electronic control system controlling the SSAT. SSAT controls platform/tower clocking to the adjoining platforms. Antennae Alignment System (AAS) between drone platforms is accomplished via yaw rotation of control arms that revolve around the tower vertical axis as shown in FIG. 1.8. AAS in addition to control arms also uses gimballed antennae mounts to control pitch and roll orientation while continuously aligning transceivers. Continuous alignment of antennae maximizes data reception and minimizes reflected energy.

ALSWOT, the network established by the described technology, enables global wireless spectrum data transmission between continents, along shorelines and over other bodies of water. ALSWOT operates primarily in International and EEZ Waters before migrating to territorial waters and finally handing off to existing land networks. The SOS provides direct wireless global network access to maritime vessels, manned and unmanned aircraft traveling above global seas, and end users within range who are located along coastlines of continents, island nations and islands and within range of major river shore lines. ALSWOT also provides global network access to end users located along shores of lakes, fiords and major river systems. ALSWOT enhances end user affordability by reducing or eliminating roaming charges for numerous transactions.

Costly investments in bandwidth and infrastructure. Bandwidth demand is steadily rising, specifically in the case of business jet Ku-band GEO-HTS capacity, which is estimated to reach nearly 13 Gbps by 2026. With its large population spread across a vast area and a geography dominated by water, no region depends more on the shipping sector than the Asia Pacific and Oceania. The trade and economic growth of the region are reliant on thousands of vessels of all types and all sizes—commercial shipping, fishing vessels, cruise ships and mega-yachts. This influence also extends beyond the region, as maritime transport is the backbone of global trade and the global economy.

As such, maritime operators are relying more and more on always-on broadband connectivity to upgrade operations, increase efficiency, transport securely and ensure that crews and passengers remain connected at sea. Given the operational and passenger demands, maritime operators need access to a broadband network that delivers the speed and reliability required by such an important segment of the economy.

### SUMMARY

A System of Systems (SOS) is described that integrates multiple, stabilized, aligned, buoyant, maritime vessels and platforms to transmit and receive electromagnetic energy forming a network. Drone Platforms Towers, deployed individually but in multitude communicate with stabilized platforms located onboard maritime vessels, manned and unmanned air vehicles, and satellites to form a remote controlled, monitored and stabilized global electromagnetic spectrum energy and data transmission network.

In one aspect, systems and methods are disclosed with a plurality of remote controlled, located and monitored platform relays for global data transmission and reception, and at least one relay linked to a maritime vessel, a satellite and an air-based vehicle.

Various methods of controlling stabilization and determining position are currently used in the control of vessel navigation. Latitude and longitude locations are available by GPS. Gyro stabilization is used to stabilize vessel motion. The use of input from these systems are used in the control, alignment, stabilization and identifying the global position of vessels. MS is one such operating system used to identify the global location of maritime vessels. MS relies on radio transmissions between vessels and satellites to identify the current location of maritime vessels that have the necessary electronics to share the data. ALSWOT is a SOS that uses individual Platforms, directionally stabilized, aligned, oriented and self-aligned to adjacent platforms to form a network capable of energy and data transmission. Antennae on platforms are directionally self-aligned to antennae on adjacent platforms to enhance performance. By creating and linking multiple platforms a global network is developed.

The system described herein is basic relying on simple physics coupled with GPS signals emitted by orbiting satellites. When processed by computing systems the signals provide latitude, longitude, height above mean sea level, and magnetic orientation. These identifying parameters of individual platforms when entered into software controlled by computer systems allow the positioning of individual platforms globally to establish and develop the global network. Detail description of more complex methods are not within the scope of this document but are known to those familiar with the art.

The principle motions of a maritime vessel are surge, sway, heave, pitch, roll and yaw. Surge, sway and heave are translation motions. Pitch, roll and yaw are rotation motions around the surge, sway and heave translation axes, respectively. Surge is the motion of a vessel along an axis of primary travel direction. Sway is the motion of vessel to either starboard or port along an axis perpendicular to surge or the primary direction of travel. Heave is an axis of motion perpendicular to sway and surge and describes the up or down motion of the vessel. The corresponding rotations around the axis described above are pitch, roll, and yaw.

For purpose of this discussion an axis referred to hereafter as the Principal Platform Axis (PPA) is the vertical axis aligned to the heave axis. Heave or direction of motion up and down in the waves is measured along this axis. This axis serves to control the combination of the pitch and roll axis or, The PPA axis is determined in using a minimum of two sets of vertically displaced sets of three or more GPS receivers. These receivers located at different heights from the platform/tower base above local mean sea level develop the PPA. PPA is stabilized with respect to a second axis or ray extending outward from the earth's center referred to as the Earth Axis (EA). PPA is aligned to EA using Gravity Fluid Leveling Techniques (GFLT), PPA is controlled with respect to EA using a closed loop electronic control system that operates horizontal and vertical thrusters and stabilizers to control and stabilize the pitch roll and yaw motion of the PPA with respect to the EA.

As stated, the alignment of the PPA axis is controlled with respect to the EA using GFLT. The GFLT is established in one method by monitoring the fluid levels of a minimum of three individual U-shaped tubes positioned equal distant (120 degrees) from one another at a specific height along the PPA axis. Using feedback from the GFLT system to operate and control thrusters and stabilizers located below the Platform Waterline (PWL) the PPA is continuously aligned to the EA using the GFLT input. Platform thrusters and stabilizers are optimally located 120 degrees apart relative to the PPA axis.

The PPA axis control system described above modulates surge, sway, heave, pitch, roll and yaw of each individual or single platform/tower. Further control of yaw, also referred to as clocking, between adjacent drone platforms is required to maximize transmission and reception efficiency. Clocking drone platforms and aligning antennae on drone platforms relative to adjacent drone platforms occurs by several processes encompassing two separate steps. Yaw control between adjacent drone platforms is accomplished using LORAN RDF techniques but to those familiar with the art multiple other techniques are available. The second step aligns antennae on one platform to antennae on adjacent drone platforms by further refining or controlling allowable limits of yaw, pitch and roll between adjacent antennae. This operation is accomplished with rotatable gimbaled antennae mounts.

The first process requires clocking the orientation of the first platform to the adjacent drone platforms. This operation is achieved using a feedback loop linking a radio emitting sources on one platform to a radio receiving sources on the adjacent platform. Linking and aligning the energy sources is achieved by maximizing the signal strength between drone platforms. Energy sources other than radio frequency electromagnetic energy can also be used. Another method of linking uses LASER energy in conjunction with FLIR. The signal variations from yaw differences between drone platforms is used as the input to a control system established by the computer driven thrusters and stabilizers.

The next method of controlling and improving data transfer efficiency between DPT is aligning antennae. By aligning antennae on the first platform to antennae on adjacent drone platforms transmission signal strength is maximized. Using gimbaled antennae mounts attached to rods that rotate around the rail located at a fixed height above the tower base. Rotation occurs both horizontally and vertically about the PA axis. These rotations described occur independently and are controlled by feedback derived from signals from adjacent towers. This step is achieved by mounting antennae to a gimbaled mount attached to a circular rail via a control arm. The control arm is free to rotate about the PA. The gimbaled antennae mount rotates independently both horizontally and vertically and joint horizontally/vertically about the circular rail thus refining the orientation between sending and receiving antennae (ref FIG. 1.8).

ALSWOT has the following benefits and traits:
A SOS that integrates current and future technology into an Affordable Maintainable Secure Communication Network (AMSCN)
A SOS operating atmospherically above water that does not rely on old technology cable systems for point to point data transmission.
A SOS that prevents hostile entities from accessing data transmitted via unmonitored and unsecured stationary cable-based systems.
A SOS that denies service disruption caused by cable damage from either natural or hostile events
A SOS that enables real time migration and routing of data between alternate stations or drone platforms to enhance cyber security.
A SOS employing anchored relay stations of both water and atmospheric variants
A SOS that employs remotely movable and positioned relay stations . . . land, water and atmospheric variants
A SOS enabling World-wide telecommunication coverage
A SOS providing enhanced global maritime access to telecommunications and data networks
A SOS that enhances LEO and Geostationary Satellite Communication capability to provide enhanced Global Coverage.
A SOS allowing global real time monitoring and location of Air Craft.
A SOS powered by fossil fuel and/or mineral based energy sources,
A SOS powered by wave, wind, and solar energy.
A SOS powered using battery stored energy technology.
A SOS allowing servers to be located onboard vessels, allowing the entire network or data distribution system to operate in International Waters.
A SOS possessing a massive natural heat sink for heat dissipation from servers and other heat generating equipment.
A SOS with the end user located near coastal and river shore lines
A SOS with end users located aboard maritime vessels and private and commercial aircraft.
A SOS that provides a cost effective, low maintenance data distribution solution based on transceivers placed aboard anchored and unanchored maritime drone platforms or drone platforms, maritime vessels, drilling platforms, UAVs, anchored and unanchored dirigibles,
A SOS that provides the optimal solution for the introduction of future communication systems technology development and upgrades.
A SOS capable of permanent state of the art upgrades without bandwidth data transmission limits.
A SOS capable of spiral development for environmental monitoring, earth science study, and future technology developments.
A SOS using Telescopic Tower Platforms
A SOS employing axis gyro-compass, GPS based Axis or other type of Physic based stabilization system.
A SOS using headless mode remote controlled technology
A SOS used to connect future mobile floating island and island-nations currently being developed.

The innovative system described further herein provides ease of access, improved reliability and maintainability, greatly reduced life cycle cost including greatly reduced capital for full system deployment. Furthermore, unlike satellites and cables that cannot be upgraded after deployment this innovative system is capable of being modified and upgraded continuously. Without the cumbersome and sometime unnecessary burdens imposed by numerous regulatory agencies a significant benefit in Affordability and Life Cycle Cost occurs.

Benefits and advantages include but are not limited to the following:
1. Spiral Development System of Systems
2. Easily Upgraded with New Technology
3. Easily expandable for increased data transmission
4. Multiple Alternatives for Data Routing
5. Multiple Routing Paths and Linking between Drone platforms, Vessels, Aircraft, and Satellites
6. State of the Art Capability in Perpetuity by Design
7. Drone platforms Capable of Remote Location Changes
8. Remote Security and Intruder Alert Protection
9. Drone Self -Maintenance Capability
10. Modular Design
11. Deployment/Relocation for Quick Natural Disaster Relief (QNDR)
12. 5G Capable by Design
13. Natural Heat Sink Advantage
14. Vessel Based Datacenters
15. Land acquisition/lease minimized
16. Tsunami disruption of communications and data minimized
17. Not impacted by changing sea levels
18. Coral reef/mangrove environmental monitoring
19. Blue Carbon Monitoring
20. Low/Sea level Hurricane Investigation
21. Rogue Wave Investigation
22. Reduced Space Trash
23. Drone Platform Towers have telescopic capability to change tower height
24. Capacity is incrementally upgradeable in capacity by adding towers
25. Routing is continuously variable by adding towers

The SOS described above, to those familiar with the art, is one variant of a Drone Tower Platform. Other variants, using similar stabilization techniques, include mono and multi-hull variants capable of sailing at higher speed or velocity are also intended. These variants are limited only by maritime vessel design parameters and intent and activities and conditions experienced during operation.

ALSWOT, by being able to incrementally upgrade capacity and technology, fundamentally provides a more robust system of data communication than the outdated technology of submarine cables. Sea conditions impacting performance are mitigated by modifying data transmission routes. When local sea conditions diminish transmission capability, data can easily be re-routed using other reources.

### BRIEF DESCRIPTION OF THE DRAWINGS

In the detailed description which follows, reference will be made to the drawing comprised of the following figures:

FIG. 1A shows an exemplary system of systems (SOS) for global telecommunication.

FIG. 1B shows an exemplary oceanic relay system based on the existing Automatic Identification System (AIS). MS broadcasts vessel locations between ships using radio frequency range spectrum. MS when uploading to satellites is named Satellite-MS (S-AIS). ALSWOT platform and ship-based transceivers transmit in the high-speed data transmission spectrum along the most trafficked ocean routes thereby reducing capital for platform construction. ALSWOT also places transceivers on drilling and other permanently located platforms.

FIG. 2 shows in more details an exemplary SOS architecture.

FIG. 3 shows an exemplary mesh network formed by devices in the SOS.

FIGS. 4-5 show exemplary self-alignment system that: (1) orients the vertical platform axis to a vertical axis or radius originating at the center of the earth, (2) clocks drone platforms to magnetic north, a designated heading, or to another platform, and (3) determines horizontal differences in height of drone platforms due to variation in local sea conditions at individual drone platforms. The concept is also applicable to any vertically aligned buoyant or non-buoyant structure requiring positional stability along its primary vertical axis.

FIG. 6 shows an exemplary sea Drone Platform Tower for the relay. Relays on maritime vessels are similar but do not require ballast storage, thrusters and stabilizers. Relays on Maritime Vessel Towers are positioned and controlled using hydraulic or pneumatic actuators connected to mounted pillow block spherical bearings or equivalent.

FIG. 7 shows exemplary gimballed antennae mount, circular rail and rotating control arms for orientation and alignment control. This embodiment of the concept relies on Radio Directional Finding (RDF) or LORAN technology for closed loop self-alignment between sending and receiving units.

### DETAILED DESCRIPTION

In this section the present invention is described with reference to the accompanying drawings in which functional embodiments of the invention are shown.

This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art.

Disclosed herein is a System of Systems (SOS) that exploits the simplicity of a multitude of motion Stabilized, Floating, Drone, Platform Towers (SFDPT) equipped with stabilized directionally controlled transceivers to relay telecommunication data using energy in the wavelength from 104 to 10-8 meters. A multitude of SFDPTs deployed in conjunction with stabilized aligned towers (SAT) placed on maritime vessels, drilling platforms, UAVs, dirigibles, manned and un-manned aircraft creates a data communication network that allows global coverage.

Air Land and Sea Wireless Optical Data Transmission (ALSWOT), is a system of motion stabilized and directed energy transmission, relay, and reception of telecommunication energy, using a plethora of remotely controlled and autonomously operated maritime relays, each self-contained and operating autonomously as part of a fully meshed network of transceivers. These transceivers placed on maritime platforms, buoys, vessels, drilling platforms, etc., enhance global transmission rates, ranges, bandwidth and performance by linking to manned and unmanned aircraft, satellites, dirigibles and other air vehicles. The system provides a fully meshed global WI-FI data and telecommunication network to serve the entire globe without the need for submarine cable data transmission. The fully linked, variably routed, fully meshed, next generation, state-of-the-art spiral development system is designed to be continuously upgradeable and provide global transmission of internet and telecommunication data globally enhancing coverage, performance, including unlimited transmission rates and volume. ALSWOT provides enhanced security, affordability and global availability to data networks.

The Drone Platform Towers (SFDPT) are remotely positioned, located and controlled allowing multiple continuously variable data transmission routes. The SOS operates primarily in International and EEZ Waters but is also deployed in coastal territorial and littoral waters along continents, island nations, islands, fjords, and up major river systems. ALSWOT globally distributes Wi-Fi traffic data via the offshore network before handing off data to land-based systems for local distribution. The SOS provides a robust economical transmission network to compete against limited capacity fiber optic-based submarine cable systems while eliminating many of disadvantages these stationary systems inherently possess including limited transmission rates.

This offshore Wi-Fi SOS network provides an efficient low-cost affordable alternate to oceanic submarine and below ground coastal fiber optic cable systems currently deployed. The SOS extends and enhances global communication networks to ocean, coastal and river areas not presently covered because economics do not support the capital investment required for cable placement. Air Land and Sea Wireless Optical Data Transmission (ALSWOT) expands capabilities of present systems by (a) expanding transmission data capacity and (b) increasing global coverage. The expanded capabilities benefit numerous institutions, organizations, and individuals as noted herein. The SOS enhances the study of global environmental science, global marine weather and life science, permits low or sea level hurricane study, rogue wave investigation, detailed ocean current investigation and assessment, ocean temperature information, and enhances many scientific endeavors while at the same time expanding access to global communication networks by less affluent individuals. By providing access and reaching less affluent individuals global illiteracy is reduced and on-line mass education is significantly enhanced. The SOS has flexibility to relocate and reposition assets in response to real time demand caused by natural or other types of disaster.

The SOS provides a platform base to maintain and deploy autonomous drones to study coral reefs, mangrove swamps, monitor Blue Carbon and evaluate multiple other environmental factors whose continuous monitoring and study promote a healthy global environment.

ALSWOT, enhances global transmission rates, ranges, traffic, routes and performance by also linking to manned and unmanned aircraft, satellites, dirigibles and air vehicles. The system provides a fully meshed incrementally expandable global WI-FI data and telecommunication network that not only serves the entire global population but also the entire global surface area. The fully linked, constantly variable routing, fully meshed, next generation, state-of-the-art, spiral development system is continuously and incrementally upgradeable. ALSWOT SOS provides global transmission of internet and telecommunication data coverage to billions of humans not presently served due to economic factors and globally enhances coverage, performance, affordability and availability.

One or more devices (alternatively designated as units, elements, systems, terminals, devices, leads or connections) are optional in the embodiments. The elements may be interconnected and or used in various configurations. In the figures and relevant descriptions of the figures, as well as in the specifications of this disclosure, some of the units or elements are optional and are not required for certain applications, embodiments and or structures. In this document the term “signal” has the most generic meaning used in the prior art and includes electrical, acoustical, infrared , X-ray, fiber optics, light sound, position, altitude ,diagnostics, beat , density, and other sensor or device or human being or animal or object generated or processed waveforms, images, pictures, symbols, wavelets, wave shapes and analog or digital or “hybrid” analog and digital signals.

Definitions

The following terms contained in this document are defined as follows:

Ray: A scalar starting at a point extending to infinity

Axis: A scalar connecting two points extending to infinity in both directions

EEZ: Economic Enterprise Zone

Co-ordinate System: A mutually perpendicular set of axes with directions noted as variables X, Y and Z. Translation along the X axis is referred to as surge, translation along the Y axis is referred to as sway, and translation along the Z axis is referred to as heave. Rotation around the X axis is referred to as pitch, rotation around the Y axis is referred to as roll, and rotation

around the Z axis is referred to as yaw.

Acronyms

To facilitate comprehension of the current disclosure frequently used acronyms and or abbreviations used in the prior art and/or in the current disclosure are highlighted in the following acronyms:
2G Second generation or 2nd generation wireless or cellular system
3D three dimensional
3G Third Generation or 3rd generation wireless or cellular system
4G Fourth Generation wireless or cellular system
5G Fifth Generation or future generation
AM Amplitude Modulation
AMC Adaptive Modulation and Coding
ACM Adaptive Coding and Modulation
Bluetooth Wireless system standardized by the Bluetooth organization
BPSK Binary Phase Shift Keying
BRA Bit Rate Agile or Bit Rate Adaptive
BST Base Station Transceiver
BWA Broadband Wireless Access
CC cross-correlation or cross-correlate
CCOR cross-correlation or cross-correlate
CDMA Code Division Multiple Access
CM Clock Modulated
CS Code Selectable
CSAA Continuously Self-Aligned Antennae
CSMA Collision Sense Multiple Access
CL Clock Shaped
COS Co-Ordinate System used for maritime vessels
DECT Digital European Cordless Telecommunication
DOF Named Degrees of Freedom Used in Maritime Systems
DS-SS Direct Sequence Spread Spectrum
EDGE Enhanced Digital GSM Evolution; Evolution of GSM or E-GSM
EEZ Waters Economic Enterprise Zone Waters
ECA Electrically Conductive Adhesives
ECP Electrically Conductive Paints
ECM Electrically Conductive Materials
ECS Electrically Conductive Sealants
EMI Electromagnetic Interference
FA Frequency Agile (selectable or switched IF or RF frequency)
FDM Frequency Division Multiplex
FH-SS Frequency Hopped Spread Spectrum
FLIR Forward Looking Infra-Red
GFLS Gravity Fluid Leveling System
FQPSK Fehr's QPSK or Feher's patented QPSK
FOC Fiber Optic Communication
FSK Frequency Shift Keying
GFSK Gaussian Frequency Shift Keying
GPS Global Positioning System
GPRS General Packet Radio Service
GMSK Gaussian Minimum Shift Keying
GSM Global Mobile System or Global System Mobile
HDR Hybrid Defined Radio
IEEE 802 Institute of Electrical and Electronics Engineers Standard Number 802
IR Infrared
LAN Local Area Network
LINA Linearly amplified or Linear amplifier or linearized amplifier
LORAN-C Long Range Radio Navigation System—Legacy System
LR Long Response
LSS Local Sea Level
MSL Mean Sea Level
MES Modulation Embodiment Selectable
MFS Modulation Format Selectable
MIMO Multiple Input Multiple Output
MISO Multiple Input Single Output
MMIMO Multimode Multiple Input Multiple Output
MSDR Multiple Software Defined Radio
NLA Non-Linearly Amplified or Non-Linear Amplifier
NQM non-quadrature modulation
NonQUAD non-quadrature modulator
NRZ Non-Return to Zero
OFDM Orthogonal Frequency Division Multiplex
PA Platform Alignment
PDA Personal Digital Assistants
PDD Position Determining Device
PDE Position Determining Entity
PS Platform Stabilization
PTT push to talk
QUAD Quadrature; also used for quadrature modulation
quad Quadrature; also used for quadrature modulation
QM Quadrature Modulation
QPSK Quadrature Phase Shift Keying
RC Remote Control
RFID Radio Frequency Identification
RFAM Radio Frequency Absorbent Materials
Rx receive
SDR Software Defined Radio (SDR)
SFDPT Stabilized Floating Drone Platform and Towers (SFDPT)
SIMO Single Input Multiple Output
SSAT Subsurface Stabilizers and Thrusters
STCS Shaped Time Constrained Signal
MSDR Multiple Software Defined Radio
TBD to be decided
TCS Time Constrained Signal
TDM Time Division Multiplex
TDMA Time Division Multiple Access
PTT Platform Telescopic Towers
TR transceiver (transmitter-receiver)
Tx transmit
TV television
UMTS Universal Mobile Telecommunication System
UNB Ultra narrowband or Ultra narrow band
URC Universal Remote Control
UWB Ultrawideband or ultra-wideband
UWN Ultrawideband-Ultra Narrow Band
VoIP Video over Internet Protocol
VoIP Voice over Internet Protocol
W waveform, wavelet or wave (signal element)
WAN Wide Area Network
WCDMA Wideband Code Division Multiple Access W-CDMA Wideband Code Division Multiple Access
Wi Fi Wireless Fidelity or related term used for systems such as IEEE 802.x_standardized systems; See also Wi-Fi
Wi-Fi wireless fidelity
WLAN Wireless Local Area Network
www World Wide Web (or WWW or) WEB
XCor cross-correlation or cross-correlator or cross-correlate

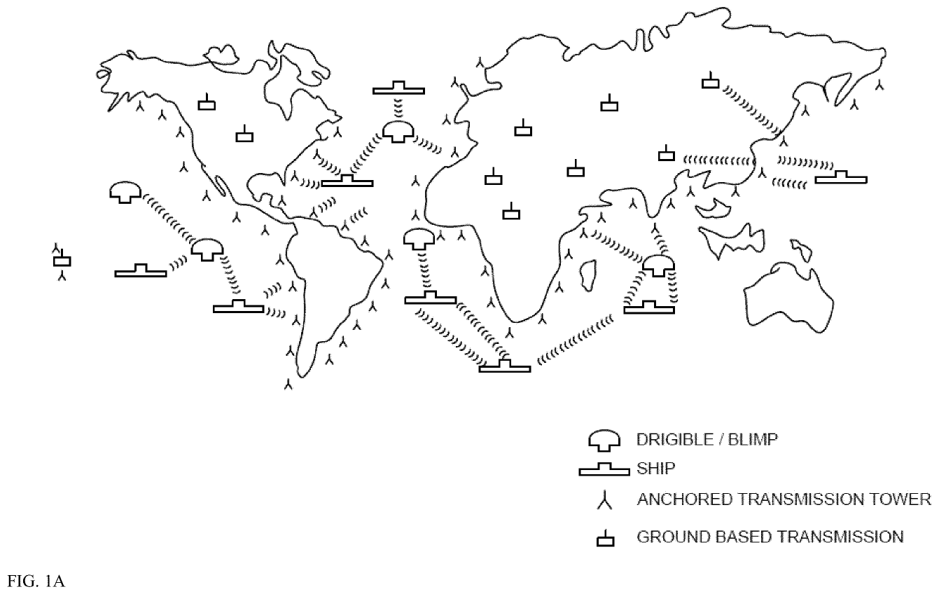

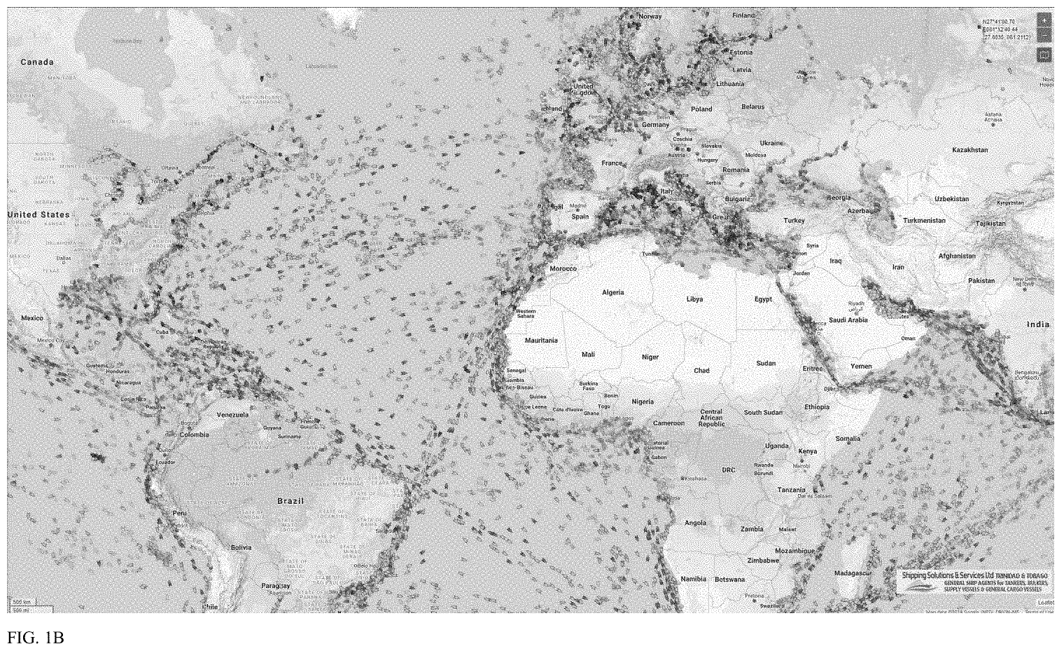

FIG. 1A shows an exemplary system of systems (SOS) for global telecommunication. In this example, maritime vessels, drone platforms, blimps, land-based towers, and satellites are part of a global mesh network that enable global communication in a cost-effective manner while providing World Wide High Speed Cost Effective 5G Capable Data Transmission System (ALSWOT) with a Remotely Controlled, Located and Monitored Platform/Buoy Based Relay System for World Wide Data Transmission and Reception that is linked using Ships, Satellites and UAVs. The system can be deployed in International Waters, EEZ Zones and Territorial Waters, Lakes, and major river systems.

FIG. 1B shows an exemplary oceanic relay system with ship-based transceivers that provide high speed traffic on most trafficked ocean routes. Many of the towers already exist by using the shipping traffic and oil platforms, and this greatly reduces the initial acquisition capital. By simply installing transceivers on ships and using mesh radio in accordance with the present invention to communicate data, a global internet network can be achieved economically.

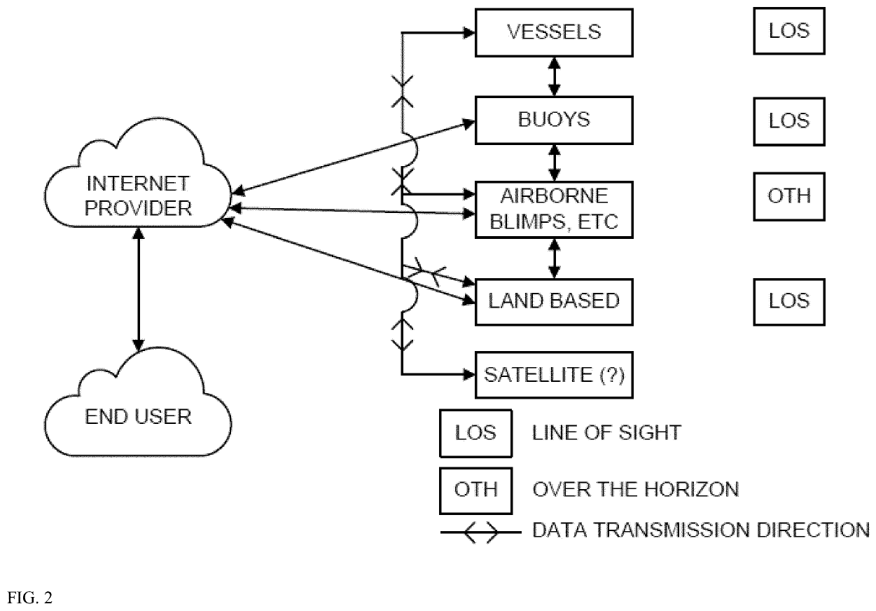

FIG. 2 shows in more details an exemplary SOS architecture. In this system, end users communicate through an Internet System Provider (ISP) using radiotelephone communicators, for example. The ISP in turn communicates with the system of system including ship vessels which can communicate by line of sight (LOS). The vessels can also communicate with drone platforms using LOS, and the drone platforms or ships can communication with airborne vehicles such as blimps, balloons, drones, or slow-moving aircraft using over the horizon (OTH) communication. The drone platforms/UAV/blimp relays can be placed in international water minimizing the permits required from local governments. If the drone platforms/ships/airborne vessels communicate with land-based networks such as earth stations, cellular towers, or Wi-Fi networks, such signals are relayed using neutrally buoyant cables or wireless methods. Moreover, each of the foregoing can communicate with orbiting satellites, among others.

The earth station may in turn be connected to a public switched telephone network, allowing communications between satellite radiotelephones, and communications between satellite radiotelephones and conventional terrestrial cellular radiotelephones or landline telephones. The satellite radiotelephone system may utilize a single antenna beam covering the entire area served by the system, or, as shown in FIG. 1, the satellite may be designed such that it produces multiple beams, each serving distinct geographical coverage areas in the system's service region. Thus, a cellular architecture similar to that used in conventional terrestrial cellular radiotelephone systems can be implemented in a satellite-based system. The satellite typically communicates with a radiotelephone over a bidirectional communications pathway, with radiotelephone communications signals being communicated from the satellite to the radiotelephone over a downlink (or forward link), and from the radiotelephone to the satellite over an uplink (or reverse link).

The radiotelephone systems require more power than conventional cellular stations and are used in areas where the small number of thinly scattered users and/or the rugged topography may make conventional landline telephone or cellular telephone infrastructure technically or economically impractical. In the ocean regions, many of the natural features which may make it commercially impractical to install conventional landline or cellular telephone infrastructures will not impede signals traveling between radiotelephones and satellites. In the ocean, LOS and OTH techniques can go long distances due to the absence of dense foliage, hills, mountain ranges, and adverse weather conditions may all impede the relatively weak signals transmitted by satellites and radiotelephones.

The system of FIGS. 1-2 increase link margins by providing SOS telecommunications repeaters that receive, amplify, and locally retransmit the downlink signal received from a satellite or from other radiotelephones thereby increasing the effective downlink margin in the vicinity of the satellite telecommunications repeaters. Furthermore, satellite telecommunications repeaters according to the present invention receive uplink signals transmitted by radiotelephones in the vicinity of the repeaters, amplify, and retransmit such signals thereby increasing the effective uplink margin.

SOS telecommunications repeaters according to the invention may also be contained in single, portable, hand-held housings. These portable repeaters may have many features including a flap, or cover, into which a patch antenna assembly may be incorporated for receiving downlink signals and retransmitting uplink signals. The flap patch antenna assembly is preferably attached to the housing of the portable unit using a hinge or swivel which allows positioning of the flap/patch antenna assembly in relation to satellites to achieve a further increase in link margin. The portable repeaters may also include various types of extensions used to support the repeater housing in an operating position. According to one embodiment of the present invention, the satellite telecommunications repeaters may employ one or more legs rotatably attached to the hand-held housing to support the repeater in an operating position.

According to another aspect of the present invention, the antennas of the SOS telecommunications repeaters used for receiving downlink signals from satellites and for retransmitting uplink signals to satellites may be aligned to SOS communicators using conventional methods such as mechanical tracking and beam steering to thereby further increase link margin.

According to another aspect of the present invention, the antennas of portable embodiments of the SOS telecommunications repeaters of the present invention may be physically aligned to transmitting satellites by users by providing a circuit which determines the strength of signals traveling between the satellites and the repeater. By moving the repeater housing as a unit, or by only moving the antennas, until the signal strength increases, better alignment and potentially increased link margin may occur.

According to another aspect of the present invention, a sleep circuit is provided for the SOS telecommunications repeaters which can place the repeater in sleep, or stand-by, mode whenever no uplink signals from radiotelephones are present. This may serve to reduce satellite receiver noise and, particularly important in hand-held embodiments relying on internal battery power, to reduce power consumption by the repeater.

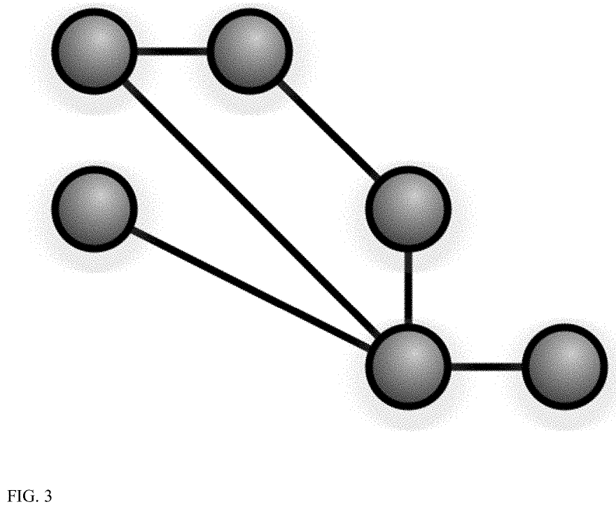

The SOS ships, drone platforms, land towers, airborne devices, and satellites form a partial mesh network. FIG. 3 shows an exemplary illustration of a partial mesh network. A fully mesh network is where each node is connected to every other node in the network. A mesh network is a local network topology in which the infrastructure nodes (i.e. bridges, switches and other infrastructure devices) connect directly, dynamically and non-hierarchically to as many other nodes as possible and cooperate with one another to efficiently route data from/to clients. This lack of dependency on one node allows for every node to participate in the relay of information. Mesh networks dynamically self-organize and self-configure, which can reduce installation overhead. The ability to self-configure enables dynamic distribution of workloads, particularly in the event that a few nodes should fail. This in turn contributes to fault-tolerance and reduced maintenance costs.

Mesh topology may be contrasted with conventional star/tree local network topologies in which the bridges/switches are directly linked to only a small subset of other bridges/switches, and the links between these infrastructure neighbors are hierarchical. While star-and-tree topologies are very well established, highly standardized and vendor-neutral, vendors of mesh network devices have not yet all agreed on common standards, and interoperability between devices from different vendors is not yet assured.

Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. Although mostly used in wireless situations, this concept can also apply to wired networks and to software interaction.

A mesh network whose nodes are all connected to each other is a fully connected network. Fully connected wired networks have the advantages of security and reliability: problems in a cable affect only the two nodes attached to it. However, in such networks, the number of cables, and therefore the cost, goes up rapidly as the number of nodes increases.

The system of FIGS. 1-3 is flexible in that it can be reconfigured for specific situations. For example, in Coastal Regions, the system can be customized for specific platform Type/Height vs UAV Location vs Population Served. In Inter-coastal Regions, factors can include Platform, Dirigible, Ships, UAV Performance vs Capital Investment. In High Sea Regions, the drone platform link to Dirigible, Ships, UAV, SATELLITE, depending on Affordability vs Performance. The platform types are standardized for cost efficiency Additionally, the system of FIGS. 1-3 claims the following features:
Drone platforms can perform loitering and motion without permanent anchorage to sea bed
Drone platforms can perform data transmission and reception from multiple other platforms, ships and UAVs
Drone platforms are capable of data redundancy
EPA requirements for EEZ and International Waters are satisfied
Requirements must be compliant with all International and EEZ rules and regulations
Power systems of Drone platforms are capable of 90-day operation without replenishment
Drone platforms are capable of remote monitoring
Drone platforms are capable of remote positioning
Control Centers can control all activities from remote location(s)
Marine vessels and Drone platforms comply with CG-ENG Standards
UAVs comply with FAA requirements
Data Transmission and Reception comply with FCC requirements in territorial waters.
Data Transmission and Reception in International and EEZ Waters are functional only to parameters of technology and economics.

As detailed above, FIGS. 1-3 show a cost effective, low maintenance system that relies on a combination of ocean-based ships, drone platforms and anchored dirigibles provides the optimal solution for future communication systems. The innovative system described herein provides ease of access, improved reliability and maintainability, greatly reduced life cycle cost including greatly reduced capital for full system deployment. Furthermore, unlike satellites that cannot be upgraded after deployment this innovative system is capable of being modified and upgraded continuously. Without the cumbersome and often unnecessary burdens imposed by local, state federal and other regulatory agencies, a significant benefit in Affordability and total Life Cycle Cost of the system occurs.

This system requires increasing distance, thus power, of data transmission from present land distances (limited by FCC broadcast power limits) to distances limited by tower height, stability, and antennae alignment. These factors combined with Affordability Analysis or economic analysis factors determine the optimal distance between towers. Once determined and integrated with maritime shipping data optimal transmission routes are established.

The optimal range and placement of equipment can be determined, and the information is relayed between freighters, stationary or movable drone platforms, blimps, among others.

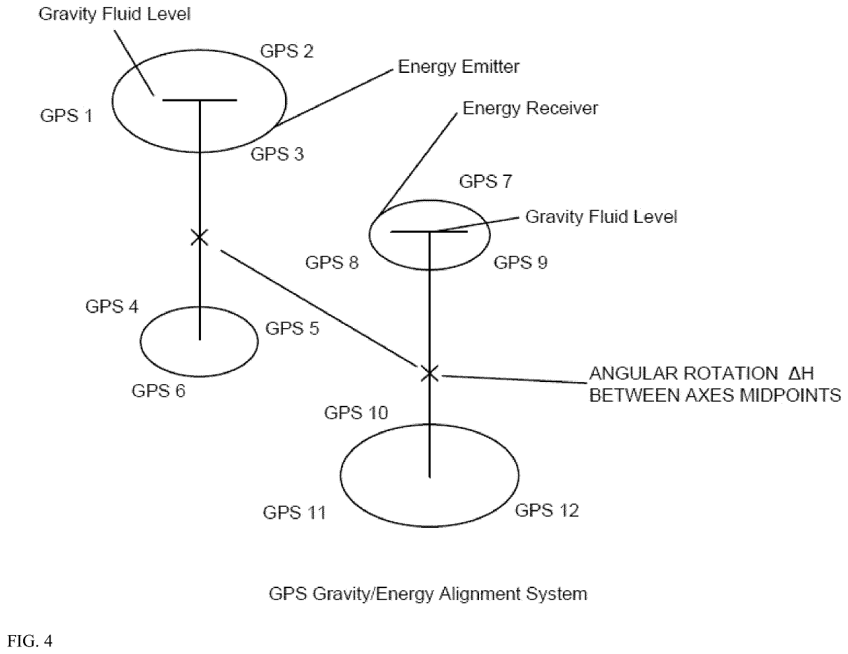

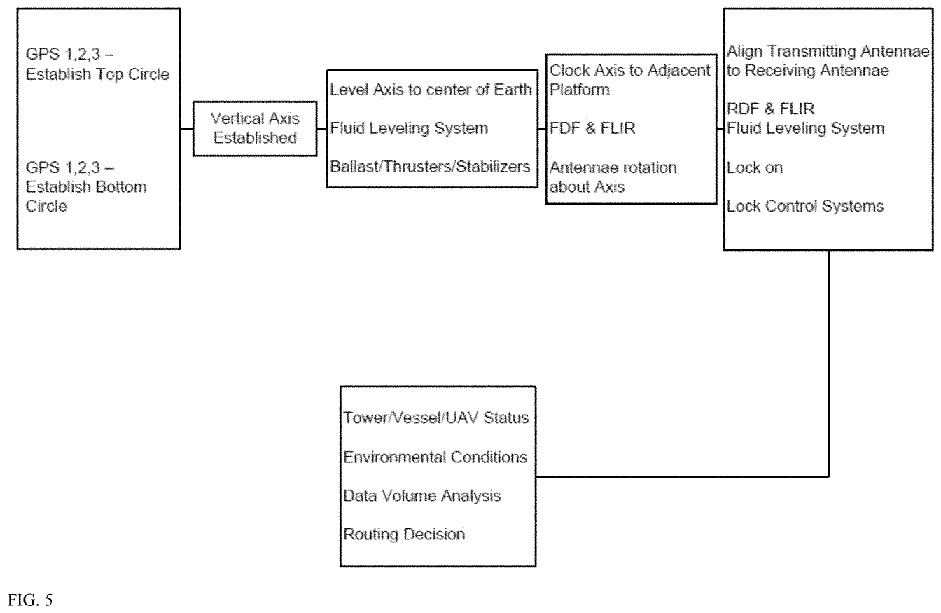

Due to the ocean deployment, alignment of the transmitter and receiver devices are needed. FIGS. 4-5 show exemplary self alignment systems that develop an axis and determines horizontal, vertical and rotational alignment relative to the center of the earth.

The system of FIGS. 4-5 easily allows the creation of single or multiple clocked cylindrical axis relative to a radius originating from the center of the earth or an axis obliquely aligned from a point at the surface of the earth to another point elevated above the earth's surface. The system also allows the determination of angular momentum between either a singular axis or multiple axes. Also, it can produce useful solutions in general engineering and construction practices that occur on either land, water, or in the atmosphere itself.

As shown in FIGS. 4-5, the components include:
1. Global Positioning System (GPS) units 1-6 and GPS Units 7-12
3. Radio Emitter or Transmitter and Receiver capable of locating origination or maximum signal strength source, i.e., LORAN
4. Laser and laser detection device capable of determining the origination of heat source
5. Closed loop control feedback system.

GPS Units 1, 2, and 3 establish point A, the center of top circle GPS Units 4, 5, and establish the center point of bottom circle B.

RDF and FLIR allow clocking of the AXIS to another remotely located cylindrical axis using GPS units 7, 8, & 9 as top circle and GPS units 10, 11, & 12 as lower circle.

Angular variation or height delta between separate axes can be determined using locations of axes midpoints.

If axis or axes are rotating both speed of rotation and relative rate of rotation between different axes is determinable using the control system.

Two axes are established using GPS 1-6 and GPS 7-12 and leveled relative to the earth surface using gravity fluid level techniques. These multiple axes can be clocked relative to one another using RDF/radio transmitter or Laser/FLIR energy systems. Thus, multiple aligned circular axes can be determined with an O deg position relative to one another.

During operation, the system can establish a vertical or inclined cylindrical axis for a tube clocked to another vertical or inclined tube axis remotely located.

The GPS is a network of about 30 satellites orbiting the Earth at an altitude of 20,000 km. The system was originally developed by the US government for military navigation but now anyone with a GPS device, be it a Satnav, mobile phone or handheld GPS unit, can receive the radio signals that the satellites broadcast. From the platform, at least four GPS satellites are ‘visible’ at any time. Each one transmits information about its position and the current time at regular intervals. These signals, travelling at the speed of light, are intercepted by the GPS receiver, which calculates how far away each satellite is based on how long it took for the messages to arrive. Once it has information on how far away at least three satellites are, the GPS receiver can pinpoint location using a process called trilateration. The more satellites there are above the horizon the more accurately your GPS unit can determine where the platform is.

GPS satellites have atomic clocks on board to keep accurate time. General and Special Relativity however predict that differences will appear between these clocks and an identical clock on Earth. General Relativity predicts that time will appear to run slower under stronger gravitational pull—the clocks on board the satellites will therefore seem to run faster than a clock on Earth. Furthermore, Special Relativity predicts that because the satellites' clocks are moving relative to a clock on Earth, they will appear to run slower. The whole GPS network has to make allowances for these effects.

FIG. 4 shows an exemplary GPS gravity and energy alignment system. In this example, two gravity fed fluid leveling units are spaced apart and associated with a plurality of GPS receivers. The first fluid leveling unit forming an energy emitter has six GPS receivers 1-6, where receivers 1-3 are associated with a top circle and receivers 4-6 are associated with a bottom circle. Similarly, the second fluid leveling unit forming an energy receiver has six GPS receivers 7-12, where receivers 7-9 are associated with another top circle and receivers 10-12 are associated with another bottom circle and in accordance with FIG. 5, the system determines an angular rotation AH between the midpoints of the axis.

The shipboard towers would just have a simple hydraulic or pneumatic leveling system (with at least 3 cylinders) based on the GPS axis determination. Controllers can be used to actively move the energy emitter relative to the energy receiver to align the axis.

FIG. 5 shows an exemplary process to perform Axis Development and Vertical Alignment Utilizing GPS Positioning and Fluid Leveling. In this system, GPS receivers 1, 2, 3 are used to establish the top circle, while GPS receivers 4-6 establish the bottom circle. Using the top and bottom circles, a vertical axis is established. Next, the system levels the axis to the center of the earth using a fluid leveling system. The leveling system can use one or more ballasts, thrusters, and/or stabilizers. Next, the system times or clocks the axis to adjacent platform, which can use FDF and/or FLIR, among others. The system can work with rotating antennas which rotate about an axis, and based on such rotations, the system can align a transmitting antenna with a receiving antenna. In combination with a fluid leveling system, the system can determine the angular rotation AH between the midpoints of the axis, and lock on the alignment of the axis with a local control system that takes in consideration the tower/vessel/unmanned vehicle status, the environmental conditions, the data volume, and routing decision, among others.

The system of FIGS. 4-5 provides an Axis and Determining Horizontal, Vertical and Rotational Alignment relative to the center of the Earth. The system develops angular momentum and other physical characteristics of single and multiple body systems with multiple Global Positioning Receivers as input.

The system can establish one or more axis/axes with orientation parallel or alternatively inclined to a radius originating from the center of earth. This is an improvement over current methods involve using surveying techniques that are cumbersome and time consuming or involve gyroscope or gyrocompass type tools/equipment. Additionally, the system can function on liquid surfaces such as lakes and oceans.

This system easily allows the creation of single or multiple clocked cylindrical axis/axes relative to a radius originating from the center of the earth or an axis/axes obliquely aligned from a point at the surface of the earth to another point elevated above the earth's surf ace. The system can also be used in systems that intersect the subsurface, surface and above surface atmosphere in contact with a fluid surface.

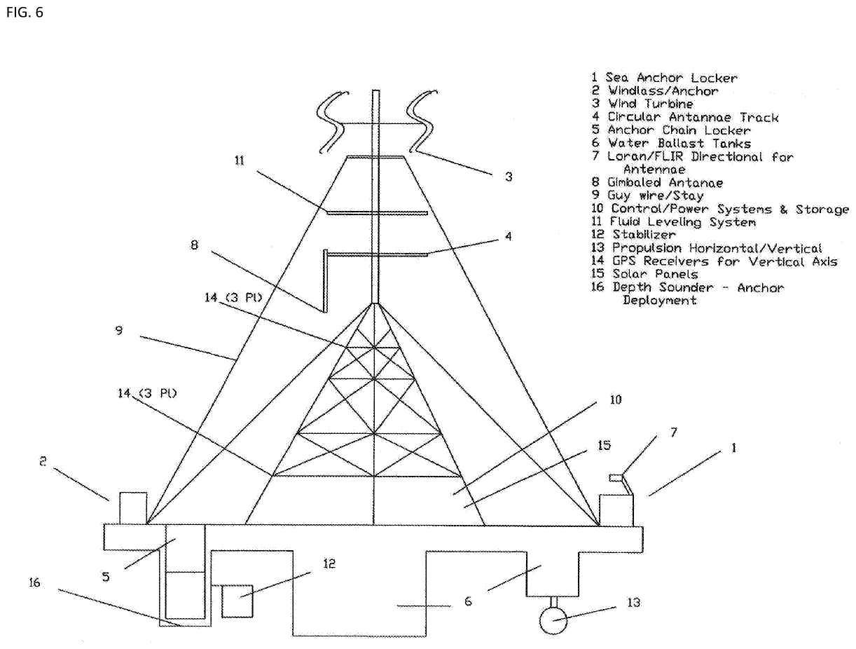

Preferably, the shortest curve between 3 points is a circle. Each circle has a center that is well defined by a midpoint of the diameter and having developed an upper and lower circle or plane, the midpoint lies on the line establishing the axis of the two circle centers and is determined by dividing the distance by two. The midpoint height (supplied by GPS) when compared to the midpoint height on the adjacent platforms determines the horizontal height delta between the adjacent drone platforms. In this manner, the angular relationship between two adjacent drone platforms relative to a horizontal tangent plane to the surface of the earth (ocean in this case can be determined and the information is then used to align the antennae refinement system of FIG. 6 that allows the feedback system to align the transmitter and receiver thus ensuring a suitably aligned transmitter/receiver system from platform to platform. The axis established on one platform can be used to vertically align that platform relative to a radius origin at the center of the earth, the Loran type system clocks the drone platforms to one another and the axis alignment from platform to platform allows the antennae and transceiver to align to each other. The platform clocking and leveling process, when coupled with the axis alignment between towers, allows the antennae and transceiver to align and lock onto each other. In other embodiments, the alignment can also use a Loran type device to clock to one another.

The above system coupled with the elimination of FCC power restrictions on and near land allow the creation of an above ocean world wide data distribution network.

FIG. 6 shows an exemplary sea platform for the relay. The platform includes sea anchor locker 1 extending from windlass anchor 2. The anchor 2 is near an anchor chain locker 5. The locker 5 can be coupled to a water ballast with a location 6. The platform has renewable power sources such as solar panels and wind turbine 3. Below them is a circular antenna track 4. An antenna 7 is provided for receivers such as LORAN or FLIR directional systems. Additionally, a gimballed antenna 8 is provided on a stanchion 9. Electronics for system control, as well as storage area 10 is provided with water proofed structures that protect items in the area 10. A fluid leveling system 11 is also provided for the platform, and a stabilizer 12 enables the platform to operate in rough sea. The platform is moved using a horizonal and/or vertical propulsion system driven either by propeller or water jet. To determine vertical axis in accordance with the system of FIGS. 4-5, a plurality of GPS receivers is mounted at two different heights on the platform. Similar drone platforms, excluding floatation equipment are planned for deployment on maritime vessels. Systems on maritime vessels utilize alignment systems comprised of pneumatic, hydraulic or electrical actuators.

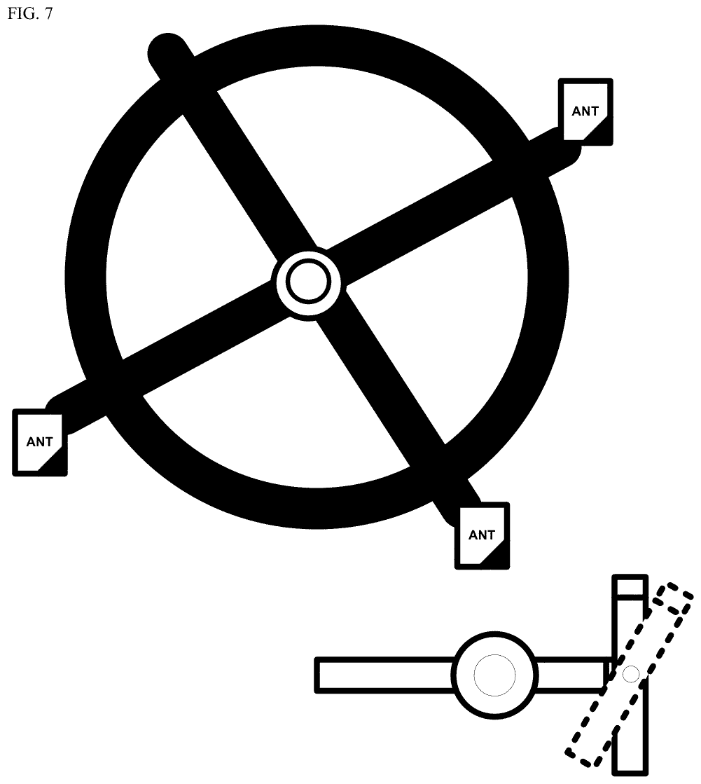

FIG. 7 shows an exemplary top view of an antenna alignment system. The system includes a wheel-like structure with a plurality of antenna holder/locator rod extending from the center of the wheel. In one embodiment, the antenna rod guide is mounted to the tower at incremental horizontal heights. A rotatable antenna holder rod is attached to the gimbaled antenna holder. Additionally, a gimbaled rotatable antenna is connected to the rod guide. The gimbaled sending and receiving units rotate and optimize sending-receiving alignment with proximate units by using a closed loop feedback system using continuously emitted electromagnetic spectrum energy broadcast for that purpose. The feedback system continuously aligns by positioning receiving and sending units at max energy levels using LORAN derived technology where directions are set by maximizing signal strength. In one embodiment, the spoke separation is 120 degrees, and the antenna rod guide is mounted to the tower horizontally at incremental heights, and a circular antenna rod guide is used with gimbaled rotatable antenna that is oriented to the netxt tower. The antenna alignment from tower to tower is sensor driven as used in tower to tower alignment.

In the foregoing example, using six GPS units that provide Latitude and Longitude locations (not relying on height above sea level readings) a cylindrical axis can be established. Using additional GPS receivers creates the potential to develop additional axes. Combining a gravity fluid or liquid level system a controlled orientation either parallel or acutely aligned to the radius of the earth can be established. The system thus permits the establishment and alignment of a cylindrical axis over distance greater then methods currently available using other techniques.

Telecommunications antennae alignment is possible using this method or process. The system is particularly applicable to alignment on surfaces capable of movement such as lake, ocean, or fluid surfaces.

Construction or alignment of structures over distance is also easily accomplished using this technique. The system is applicable to all moving vehicles utilizing alignment-sensitive system elements such as military aircraft, commercial aircraft, armored tanks, helicopters, ships, aircraft carriers, submarines, spacecraft, missiles, and so forth. In addition, it applies to numerous instruments, sensors, radar, INS, FLIR, and gun sighting devices being only examples. Given the specific force vectors any of the known means, such as computer programs and other calculating methods, can be used to determine the misalignment.

In short, an Axis Development and Vertical Alignment Utilizing GPS Positioning and Fluid Leveling Techniques can be used that easily allows the creation of single or multiple clocked cylindrical axis relative to a radius originating from the center of the earth or an axis obliquely aligned from a point at the surface of the earth to another point elevated above the earth's surface.

ALSWOT is a system of systems for global internet connectivity that is remotely controlled and monitored and relocatable as needed, with stabilized towers, unfettered by FCC power output limits, that has further refinement of transmission and receiving equipment. ALSWOT thus provides competition and improvement over the old disrupt able technology of undersea cables. The ALSWOT can be leased for its tower height to shored based distributors as AMT leases tower height for land-based towers to customers.

The invention further provides methods and procedures performed by the structures, devices, apparatus, and systems described herein before, as well as other embodiments incorporating combinations and sub combinations of the structures highlighted above and described herein.

All publications including patents, pending patents and reports listed or mentioned in these publications and/or in this patent/invention are herein incorporated by reference to the same extent as if each publication or report, or patent or pending patent and/or references listed in these publications, reports, patents or pending patents were specifically and individually indicated to be incorporated by reference. The invention now being fully described, it will be apparent to one of ordinary skill in the art that many changes and modifications can be made thereto without departing from the spirit or scope of the appended claims. In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A system, comprising:
a plurality of remote controlled, located and monitored platform relays for global data transmission and reception, and
at least one relay linked to a maritime vessel, a satellite and an air-based vehicle.

2. The system of claim 1, wherein a transceiver coupled to one or more relays receives Internet data on land, sea, or air.

3. The system of claim 1, wherein the relay comprises a land-based relay.

4. The system of claim 1, wherein the relay comprises an air-based relay.

5. The system of claim 1, wherein the relay comprises a water-based relay.

6. The system of claiml, wherein the relay comprises a satellite-based relay.

7. The system of claim 1, wherein the relay comprises a land-based relay in communication with an air-based relay, a satellite-based relay and a water-based relay.

8. The system of claim 1, wherein the relays form a mesh-network to avoid reliance on a point to point data transmission.

9. The system of claim 1, comprising a mesh-network to prevent hostile sources from gaining access to communication system data

10. The system of claim 1, comprising real time migration and routing of data between alternate station locals to enhance cyber security.

11. The system of claim 1, wherein the relay is moveable.

12. The system of claim 1 wherein the relay is anchored.

13. The system of claim 1, comprising real time monitoring and location of air vehicles world-wide.

14. The system of claim 1, comprising the rebroadcast of frequencies in the electromagnetic spectrum while operating above International and EEZ waters.

15. The system of claim 1, comprising the rebroadcast of transmission frequencies in the electromagnetic spectrum not assigned for use over International and EEZ Waters.

16. The system of claim 1, comprising the rebroadcast of transmission frequencies of claims 14 and 15 in territorial waters.

17. The system of claim 1, wherein the relays communicate with LEO and Geostationary Satellite for Global Coverage.

18. The system of claim 1, comprising a battery power storage device that is charged by energy generated from fossil fuels, wave, wind, solar, or electromagnetic energy.

19. The system of claim 1, comprising one or more servers communicating with the relays, wherein the servers are positioned on maritime vessels moveable and operable in International and EEZ waters.

20. The system of claim 1, comprising a stabilizer coupled to a relay platform.

21. The system of claim 1, comprising vertical and horizontal thrusters coupled to a relay platform.

22. The system of claim 1, comprising separate groupings of three geo-positioning receivers with each grouping a predetermined vertical distance from the other.

23. The system of claims 1 and 22, comprising receivers and output signals that independently establishing latitude, longitude, and height above local mean sea level

24. The system of claims 1, 22, 23 comprising the construct of a center point, a radius and a plane using principles of geometry and providing output signals.

25. The system of claims 1, 22, 23 and 24 comprising a best fit connection of center points to establish a platform tower vertical axis.

26. The system of claims 1 and 24, comprising three or more liquid leveling sensors, spring mounted accelerometers, or other devices positioned at rays 120 degrees from each other used to level the planar surface

27. The system of claims 1,23 and 26, comprising feedback signals to an electronic control unit to operate stabilizers and thrusters

28. The system of claim 17, comprising a gimbal mounted transceiver attached to the platform tower.

29. The system of claim 1, comprising a thruster system powered by mechanical drives of fossil fuel powered engines.

30. The system of claim 1, comprising a thruster system powered by water jet drive.

31. The system of claim 1, comprising a thruster system driven by electric motors.
